(19) United States
(12) Patent Application Publication
(10) Pub. No.: US 2006/0078635 A1
(43) Pub. Date: Apr. 13, 2006

(54) Welding shoe, plastic welding shoe extruder, method for producing a plastic welded seam

(76) Inventor: Franz-Josef Herz, Neuwied (DE)

Correspondence Address: JORDAN AND HAMBURG LLP, 122 EAST 42ND STREET, SUITE 4000, NEW YORK, NY, 10168, US

(21) Appl. No.: 11/227,846

(22) Filed: Sep. 15, 2005

(30) Foreign Application Priority Data
Oct. 12, 2004 (DE) 10 2004 049 793.1
Oct. 12, 2004 (DE) 10 2004 049 811.3

(51) Int. Cl. B28B 3/00

(52) U.S. Cl. 425/87

(57) ABSTRACT

A welding shoe, a plastic welding extruder, which has a conveying device, a housing for the conveying device, a melting chamber, a welding shoe and/or a nozzle device, and a method for producing a plastic welded seam by means of a plastic welding extruder wherein a ceramic is used at least partly as a material of construction, as a result of which contamination of the melted material and wear are avoided and an increase in the temperature of the composition becomes possible, so that highly fluorinated plastics (PTFE (Teflon), FEP (hexafluoropropylene copolymer), PFA (perfluoroalkoxyalkane) or the like, high-tech plastics or the like can be processed.

### BACKGROUND OF THE INVENTION

The invention relates to a welding shoe for a plastic welding extruder, a plastic welding extruder and a method for producing a plastic welded seam by means of a plastic welding extruder.

At the present time, plastic welding is as widespread as welding metals. For this purpose, plastic welding extruders are used, which are equipped with their own air supply or with an outside air supply. The plastic welding extruder is driven by an electric motor. The material to be welded (welding wire, granulate), which usually is polyethylene (PE), polypropylene (PP), polyvinylidene fluoride (PVDF) or polyvinyl chloride (PVC) is supplied to the extruder screw over a wire infeed, is supplied to the extruder screw, by means of which it is granulated. Subsequently, the extruder screw presses the granulate into the melting chamber, in which it is melted to a homogeneous composition in order to emerge subsequently from the extruder nozzle. At the same time, the joint parts are brought to the welding temperature by warm air. By applying the plasticized melted material to the joint parts, the welded seam is produced by the welding shoe. Depending on the welded seam (filet seam, X seam, film seam, V seam, corner seam, or the like), different welding shoes, adapted to the geometry of the welded seam, are used.

Different materials, from which the welding shoe is produced, are state of the art. Metal welding shoes are regarded as disadvantageous because of the high heat conductivity. Meanwhile, there has been a change to welding shoes, produced partly or completely from polytetrafluoroethylene (PTFE, Teflon). It is, however, a disadvantage that, due to the use of Teflon, the maximum composition temperature is limited to about 270° C., so that highly fluorinated plastics (PTFE (Teflon), or the like) and high tech plastics, or the like cannot be processed. Moreover, there is wear of the Teflon over time, so that the welding shoe must be exchanged.

As a rule, the components of the plastic welding extruder, which come into contact with the welding wire, the granulate and/or the material to be melted, consist of metal. However, it is a disadvantage that plastics, such as polyvinyl chloride (PVC), release chemically aggressive materials, such as hydrogen chloride vapors, when heated, which attack the material of these components and, with that, reduce their service life. In addition, an oxide layer is formed, the abrasive wear debris of which can get into the welded seam, resulting in a qualitatively lower grade welded seam.

### SUMMARY OF THE INVENTION

On the other hand, the inventive welding shoe for a plastic welding extruder, the inventive plastic welding extruder and the inventive method for producing a plastic welded seam by means of a plastic welding extruder have the advantage that ceramic is used as material. If the inventive welding shoe consists of ceramic, there is practically no wear and molten residues of plastic do not remain attached to it. In the case of the inventive plastic welding extruder, the conveying device, housing of the conveying device, melting chamber, welding shoe and/or nozzle device of which consist at least partially of ceramic, the purpose of the ceramic is only to avoid contamination of the melted material during the process, which, in other respects, is conventional. In addition, due to the ceramic, it is possible to increase the composition temperature, so that highly fluorinated plastics (PTFE (Teflon), FEP (hexafluoropropylene copolymers), PFA (perfluoroalkoxyalkanes), or the like), high-tech plastics, or the like can also be processed.

According to an advantageous development of the inventive welding shoe, the ceramic is engineered ceramic.

According to an additional, advantageous development of the inventive welding shoe, the material of the welding shoe is aluminum titanate (Al₂TiO₅).

According to an additional advantageous development of the inventive welding shoe, the material of the welding shoe is partly stabilized zirconium oxide (ZrO₂₄TzP).

According to an additional advantageous development of the inventive welding shoe, the material of the welding shoe is silicon carbide (SiC).

According to an additional advantageous development of the inventive welding shoe, the welding shoe is connected detachably with the plastic welding extruder by means of the connecting device, so that the welding shoe can be exchanged easily and quickly depending on the welding seam geometry that is required.

According to an advantageous development of the inventive plastic welding extruder, the ceramic is engineered ceramic.

According to an additional advantageous development of the inventive plastic welding extruder, the material is silicon-filled silicon carbide (SiSiC). The advantage of this material lies therein that it is hard, stable and unbreakable. In addition, the low thermal conductivity of the silicon carbide is compensated for by a high thermal connectivity of the silicon. As a result, the thermal conductivity is ideal so that the heat of the strip heater, surrounding the melting chamber, can be passed on optimally to the melted material.

Further advantages and advantageous developments of the invention may be inferred from the description of the drawing that follows and from the claims.

Examples of the object of the invention are explained in greater detail in the following and shown in the drawings.

### BRIEF DESCRIPTION OF THE DRAWINGS:

FIG. 1 shows a side view of an inventive plastic welding extruder,

FIG. 2 shows a plan view of an inventive plastic welding extruder,

FIG. 3 shows a detailed view of an inventive plastic welding extruder,

FIG. 4 shows a side view of an inventive welding shoe,

FIG. 5 shows a front view of an inventive welding shoe, and

FIG. 6 shows a view from below of an inventive welding shoe.

### DESCRIPTION OF THE PREFERRED EMBODIMENTS

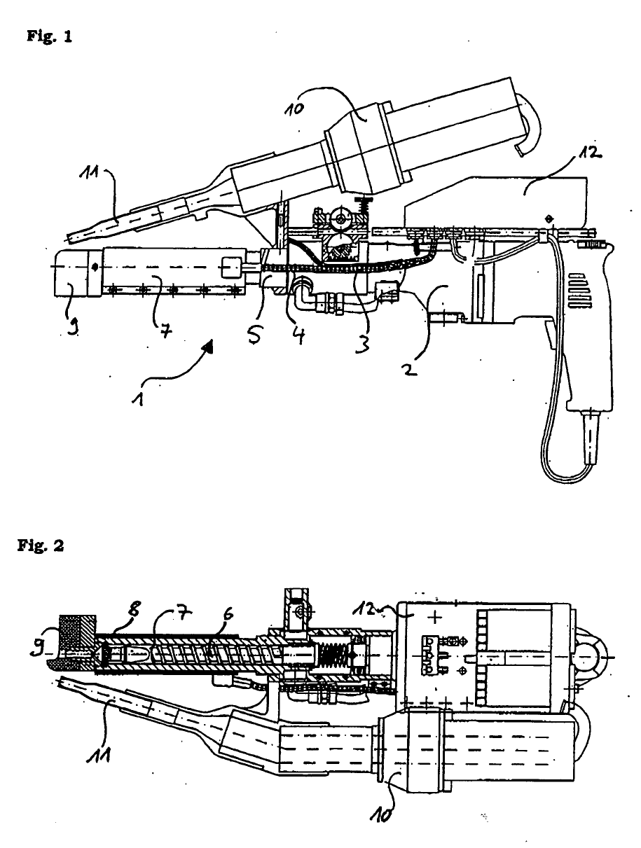

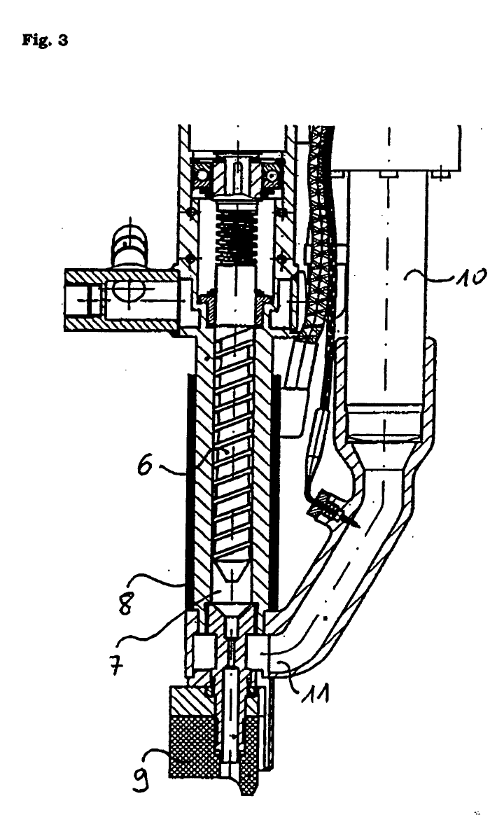

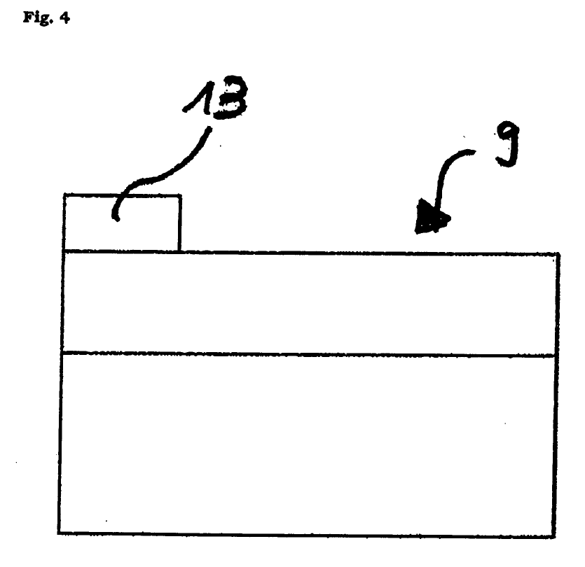

FIGS. 1, 2 and 3 show a side view, a plan view and a detailed view of an inventive plastic welding extruder 1. The latter has a driving mechanism 2 (electric motor), which pulls the welding wire 3 (granulate) over the wire infeed 4 into the extruder 5. The welding wire 3 is granulated by the conveying device 6, which, in the example shown, is formed by an extruder screw. The granulate is melted in the melting chamber 7, the heat, required for this, being generated by a strip heater 8. The melted material leaves the inventive plastic welding extruder 1 through the welding shoe 9, which, pursuant to the invention, is made from a ceramic or an engineered ceramic and is deposited on the joint parts, which are not shown. In addition, the joint parts are heated over a pre-heating nozzle 11 by means of a heating gas device 10, which is supplied by its own air or by outside air. Adjustments, for example, to the temperature of the composition, are made by means of a controller 12.

Pursuant to the invention, the conveying device 6, the housing of the conveying device 6, the melting chamber 7, the welding shoe 9 and/or the pre-heating nozzle 11 of the nozzle device are made at least partly from ceramic, so that impurities cannot reach the melted material.

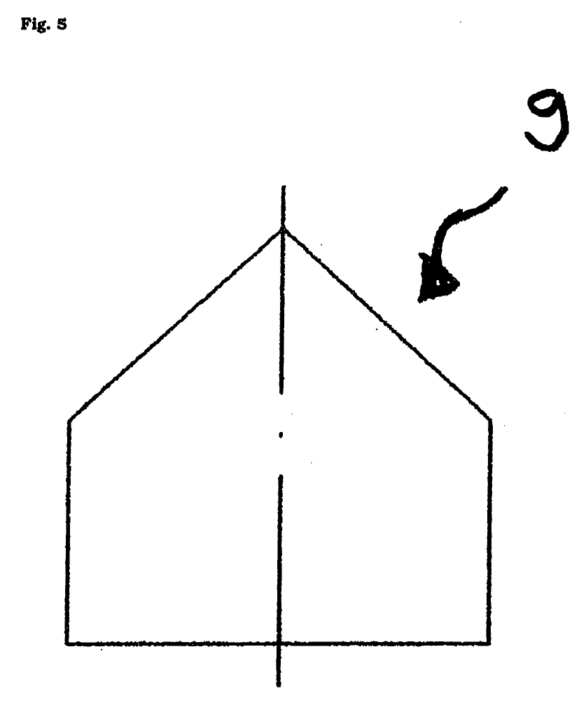

FIG. 4 shows a side view of an inventive welding shoe 9, which has a high spot 13 (nose), which serves as a guide and in which the joint, formed by the joint parts, is passed. In addition, the high spot 13 has the task of limiting the emergence of the melted material

FIG. 5 shows a front view of an inventive welding shoe 9. The surface geometry is suitable for producing a filet seam. Of course, other angles and/full surface geometries are conceivable, so that the inventive welding shoe 9 can be used for different welded seams.

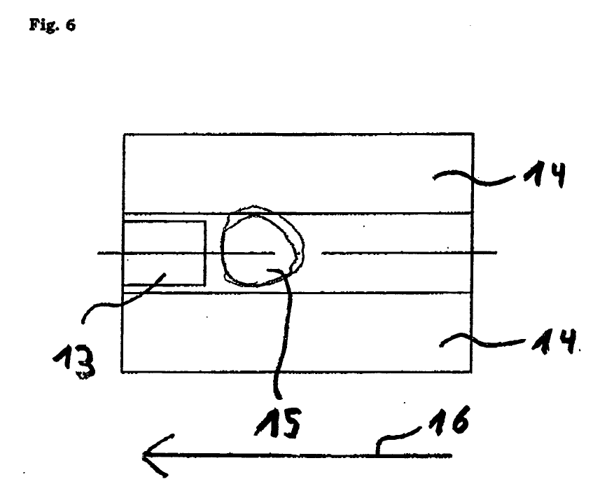

FIG. 6 shows a view from below of an inventive welding shoe 9. Due to the high spot 13 in the joint, the surfaces 14 make contact with the joint parts. The melted material is pressed through the opening 15 and into the joint, formed by the joint parts, and achieves the desired form due to the movement of the plastic welding extruder 1 in the direction 16 and the inventive welding shoe 9. The high spot 13 prevents the escape of melted material in the direction of movement 16.

All the distinguishing features, shown here, may be essential to the invention individually as well as in any combination with one another.

### LIST OF REFERENCE SYMBOLS

1 plastic welding extruder
2 driving mechanism
3 welding wire
4 wire infeed
5 extruder
6 conveying direction
7 melting chamber
8 strip heater
9 welding shoe
10 heating gas device
11 pre-heating nozzle
12 controller
13 high spot
14 area
15 opening
16 direction of movement

1. Welding shoe for a plastic welding extruder for producing a welded seam (filet seam, X seam, film seam, V seam, corner seam, or the like) comprising:
a device for connecting the welding shoe to an opening of the plastic welding extruder, through which melted material is discharged,
at least one channel for passing the melted material through the welding shoe, the channel corresponding with the opening of the plastic welding extruder through which the melted material is discharged,
at least one outlet opening for the melted material, and
a guide which is required for the welded seam, wherein the material of the welding shoe is a ceramic.

2. The welding shoe of claim 1, wherein the ceramic is an engineered ceramic.

3. The welding shoe of claim 1 wherein the material of the welding shoe is aluminum titanate (Al₂TiO₅).

4. The welding shoe of claim 1, wherein the material of the welding shoe is partially stabilized zirconium oxide (ZrO₃₄TzP).

5. The welding shoe of claim 1, wherein the material of the welding shoe is silicon carbide (SiC).

6. The welding shoe of claim 1, wherein due to the connecting device, the welding shoe can be detached from the plastic welding extruder.

7. A plastic welding extruder comprising:
a melting chamber for melting material,
a driving mechanism for a conveying device in a housing for supplying melted material to the melting chamber,
a welding shoe for discharging the melted material for forming a welded seam on the joint parts which are to be welded, and
a nozzle device, through which a gaseous medium can flow in order to heat the joint parts,
wherein the material of the conveying device, of the housing of the conveying device, of the melting chamber, of the welding shoe and/or of the nozzle device is at least partially a ceramic.

8. The plastic welding extruder of claim 7, wherein the ceramic is engineered ceramic.

9. The plastic welding extruder of claim 7, wherein the material is a silicon-filled silicon carbide (SiSiC).

10. Method for producing a plastic welded seam by means of a plastic welding extruder, especially for avoiding contamination of the melted material in the case of an otherwise conventional method, a plastic welding extruder is used, a conveying device, a housing of the conveying device, a melting chamber, a welding shoe and/or a nozzle device of which is at least partially a ceramic.

11. The method for producing a plastic welded seam by means of a plastic welding extruder of claim 10, wherein the ceramic is engineered ceramic.
